(19) United States
(12) Patent Application Publication
(10) Pub. No.: US 2013/0324235 A1
(43) Pub. Date: Dec. 5, 2013

(54) METHOD AND APPARATUS FOR GENERATING ONLINE GAME PACKET FOR EFFECTIVE DETECTION OF ILLEGAL USER

(71) Applicant: Electronics and Telecommunications Research Institute, Daejeon (KR)

(72) Inventors: Ju Young KIM, Daejeon (KR); Chang Joon PARK, Daejeon (KR)

(21) Appl. No.: 13/906,886

(22) Filed: May 31, 2013

(30) Foreign Application Priority Data
May 31, 2012 (KR) 10-2012-0057979
Apr. 3, 2013 (KR) 10-2013-0036384

(51) Int. Cl. A63F 13/00

(52) U.S. Cl. CPC A63F 13/00
USPC 463/29

(57) ABSTRACT

A method and an apparatus for generating an online game packet for effective detection of an illegal user are disclosed. A method of generating an online game packet for effective detection of an illegal user may include acquiring online game packet generation information comprising protocol identification (ID) information and packet size information, determining a type of online game packet having a basic packet structure including a protocol ID field corresponding to the protocol ID information, a packet size field corresponding to the packet size information and at least one protocol field and further including at least one of a protocol index field and an animation index field, and generating the online game packet using the online game packet generation information based on the type of online game packet.

### CROSS-REFERENCE TO RELATED APPLICATION

This application claims the priority benefit of Korean Patent Application No. 10-2012-0057979, filed on May 31, 2012, and Korean Patent Application No. 10-2013-0036384, filed on Apr. 3, 2013, in the Korean Intellectual Property Office, the disclosures of which are incorporated herein by reference.

### BACKGROUND

1. Field of the Invention

The present invention relates to a method and an apparatus for generating an online game packet for effective detection of an illegal user, and more particularly, to a method and an apparatus for generating an online game packet for effective detection of an illegal user which generates an online game packet to detect an online game bot of an illegal user.

2. Description of the Related Art

A game bot is a program that plays an online game for users and has become a critical issue in online games recently. In particular, in online games, a game bot is executed along with an online game client to produce a mouse event or keyboard event, thereby automatically performing a variety of activities in the online games, for example, hunting, gathering or manufacturing. A game bot may disrupt the order of an online game and cause unpredictable damage to a plurality of online game users. To prevent damage from game bots, methods of detecting game bots by analyzing trajectories of moving online game clients or behavioral patterns are introduced. Such methods analyze activities of game bots on the assumption that the game bots have different behavioral patterns from general game clients. However, these methods of analysis may mistake normal users who behave similarly to game bots as the game bots or fail to detect game bots that behave similarly to normal users. Thus, research on effective detection of game bots is ongoing.

### SUMMARY

According to an aspect of the present invention, there is provided a method of generating an online game packet for detection of an illegal user, the method including acquiring online game packet generation information including protocol identification (ID) information, packet size information and character status information of a game client, determining a type of online game packet having a basic packet structure including a protocol ID field corresponding to the protocol ID information, a packet size field corresponding to the packet size information and at least one protocol field corresponding to the character status information of the game client, and further including at least one of a protocol index field and an animation index field, and generating the online game packet using the online game packet generation information based on the type of online game packet.

The type of online game packet may be any one of a first type having the basic packet structure and further including the protocol index field, a second type having the basic packet structure and further including the animation index field, and a third type having the basic packet structure and further including the protocol index field and the animation index field.

When the online game packet is the first type, the generating of the online game packet may include acquiring a predetermined protocol index table, generating data values of the protocol index field and the at least one protocol field using the character status information based on the protocol index table, and encoding the data value of the protocol index field.

The protocol index table may include at least one protocol index number and information about a structure of a protocol field corresponding to the at least one protocol index number.

When the online game packet is the second type, the online game packet generation information may further include character motion information about the game client, and the generating of the online game packet may include acquiring a predetermined animation index table, generating a data value of the animation index field using the character motion information based on the animation index table, and encoding the data value of the animation index field.

The animation index table may include at least one animation index number and information about a character motion type of the game client corresponding to the at least one animation index number.

When the online game packet is the third type, the online game packet generation information may further include character motion information about the game client, and the generating of the online game packet may include acquiring a predetermined protocol index table, acquiring a predetermined animation index table, generating data values of the protocol index field and the at least one protocol field using the character status information based on the protocol index table, generating a data value of the animation index field using the character motion information based on the animation index table, and encoding the data value of the protocol index field and the data value of the animation index field.

The protocol index table may include at least one protocol index number and information about a structure of a protocol field corresponding to the at least one protocol index number, and the animation index table may include at least one animation index number and information about a character motion type of the game client corresponding to the at least one animation index number.

The protocol index field may be a subfield of the protocol ID field.

According to an aspect of the present invention, there is provided an apparatus for generating an online game packet for detection of an illegal user, the apparatus including an online game packet generation information acquisition unit to acquire online game packet generation information including protocol identification (ID) information, packet size information, and character status information of a game client, an online game packet type determination unit to determine a type of online game packet basically having a packet structure including a protocol ID field corresponding to the protocol ID information, a packet size field corresponding to the packet size information and at least one protocol field corresponding to the character status information of the game client, and further including at least one of a protocol index field and an animation index field, and an online game packet generation unit to generate the online game packet using the online game packet generation information based on the type of online game packet.

The type of online game packet may be any one of a first type having the basic packet structure and further including the protocol index field, a second type having the basic packet structure and further including the animation index field, and a third type having the basic packet structure and further including the protocol index field and the animation index field.

When the online game packet is the first type, the online game packet generation unit may include a protocol index table acquisition unit to acquire a predetermined protocol index table, a data value generation unit to generate data values of the protocol index field and the at least one protocol field using the character status information based on the protocol index table, and an encoding unit to encode the data value of the protocol index field.

The protocol index table may include at least one protocol index number and information about a structure of a protocol field corresponding to the at least one protocol index number.

When the online game packet is the second type, the online game packet generation information may further include character motion information about the game client, and the online game packet generation unit may include an animation index table acquisition unit to acquire a predetermined animation index table, a data value generation unit to generate a data value of the animation index field using the character motion information based on the animation index table, and an encoding unit to encode the data value of the animation index field.

The animation index table may include at least one animation index number and information about a character motion type of the game client corresponding to the at least one animation index number.

When the online game packet is the third type, the online game packet generation information may further include character motion information about the game client, and the online game packet generation unit may include a protocol index table acquisition unit to acquire a predetermined protocol index table, an animation index table acquisition unit to acquire a predetermined animation index table, a first data value generation unit to generate data values of the protocol index field and the at least one protocol field using the character status information based on the protocol index table, a second data value generation unit to generate a data value of the animation index field using the character motion information based on the animation index table, and an encoding unit to encode the data value of the protocol index field and the data value of the animation index field.

The protocol index table may include at least one protocol index number and information about a structure of a protocol field corresponding to the at least one protocol index number, and the animation index table may include at least one animation index number and information about a character motion type of the game client corresponding to the at least one animation index number.

The protocol index field may be a subfield of the protocol ID field.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an online game network and a packet structure according to an exemplary embodiment of the present invention;

FIG. 2 illustrates a method of generating an online game packet for detection of an illegal user according to an exemplary embodiment of the present invention;

FIG. 3 illustrates a first type of online game packet according to an exemplary embodiment of the present invention;

FIG. 4 illustrates a second type of online game packet according to an exemplary embodiment of the present invention;

FIG. 5 illustrates a third type of online game packet according to an exemplary embodiment of the present invention; and

FIG. 6 illustrates an apparatus for generating an online game packet for detection of an illegal user according to an exemplary embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

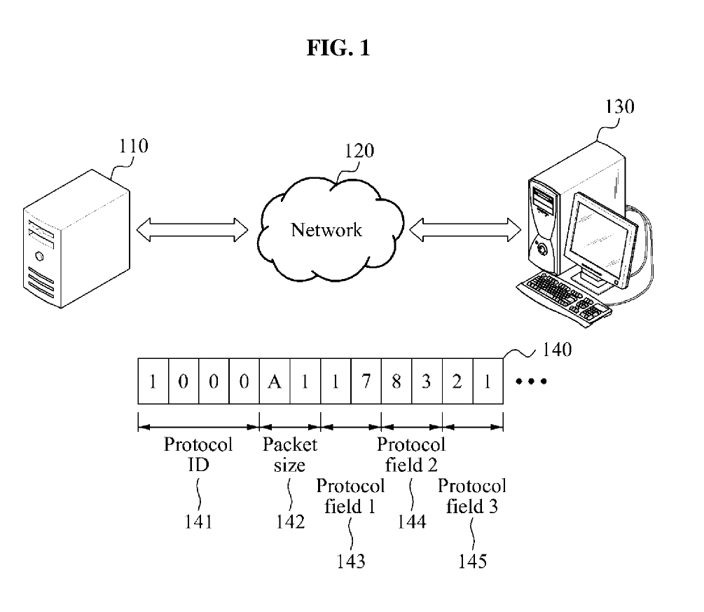

FIG. 1 illustrates an online game network and a packet structure according to an exemplary embodiment of the present invention.

Referring to FIG. 1, an online game system may include a game server 110, a network 120, and a game client 130. In detail, the game server 110 may provide an online game so that the game client 130 connected to the game server 110 through the game network 120 plays the online game. The game client 130 may connect to the game server 110, download and install an online game client program, and play the online game using the online game client program.

When a user plays the online game, the game client 130 may transmit/receive a game packet 140 to/from the game server 110 through the network 120. In detail, the game client 130 may exchange information needed for the online game with the game server 110 through transmission and reception of the game packet 140, thereby playing the online game. The game packet 140 transmitted and received between the game client 130 and the game server 110 may have different structures depending on online games, wherein the game packet 140 may generally include a protocol identification (ID) field 141, a packet size field 142, and at least one of protocol fields 143 to 145. Here, the protocol ID field 141 may include protocol ID information indicating a type of information included in the packet. For example, through analysis of the protocol ID field 141, it may be verified whether the packet is a move packet, an attack packet, or a login packet. The packet size field 142 may include information about a size of each game packet, and the at least one of protocol fields 143 to 145 may include specific information about the game packet to be transmitted, for example, character status information of the game client.

Generally, an illegal user may cheat at the online game using the game packet 140 transmitted and received between the game client 130 and the game server 110. For example, the illegal user may capture and analyze the game packet 140 transmitted and received between the game client 130 and the game server 110 to change the packet. Subsequently, the illegal user may transmit the changed packet to the game server 110, thereby cheating at the online game.

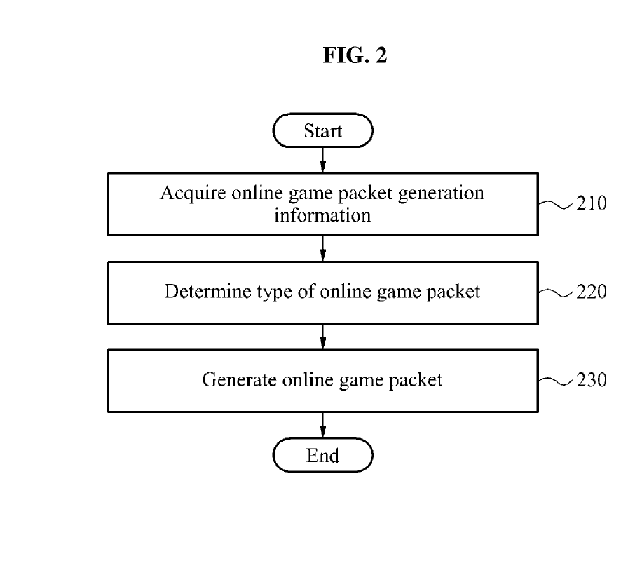

FIG. 2 illustrates a method of generating an online game packet for detection of an illegal user according to an exemplary embodiment of the present invention.

Referring to FIG. 2, the method of generating the online game packet for detection of the illegal user, hereinafter referred to as the “online game packet generation method, may acquire online game packet generation information including protocol ID information, packet size information, and character status information of a game client in operation 210. Here, the protocol ID information may be information to indicate a type of the packet. The packet size information may include information about a size of a packet transmitted and received by a game server and the game client. The character status information may include information about an online game status of the game client. For example, the character status information may include information about a current coordinate or a destination coordinate of a character corresponding to the game client in the online game. The online game packet generation information may further include character motion information of the game client. Here, the character motion information may be information about a motion of the character corresponding to the game client, for example, a walking motion and a hunting motion.

Subsequently, the online game packet generation method may determine a type of online game packet having a basic packet structure including a protocol ID field corresponding to the protocol ID information, a packet size field corresponding to the packet size information and at least one protocol field corresponding to the character status information of the game client and further includes at least one of a protocol index field and an animation index field in operation 220. In particular, an illegal user may cheat at the online game by changing a packet transmitted and received between the game server and the game client. In this instance, the illegal user may use a general packet structure including a protocol ID, a packet size field and at least one protocol field. The online game packet generation method generates an online game packet by adding an additional field to the general packet structure, thereby effectively detecting the illegal user.

In detail, the online game packet generation method may divide an online game packet structure into three types. A first type may be an online game packet having the basic packet structure and further including the protocol index field, and a second type may be an online game packet having the basic packet structure and further including the animation index field. A third type may be an online game packet having the basic packet structure and further including the protocol index field and the animation index field. Here, the protocol index field is a subfield of the protocol ID field, and the online game packet generation method may generate an online game packet having a variable structure using the protocol index field. The animation index field may include information about a character motion type of the game client.

Further, in the exemplary embodiment, the online game packet generation method may determine a type of online game packet using a predetermined rule based on the online game packet generation information.

The online game packet generation method may generate the online game packet using the online game packet generation information based on the type of online game packet in operation 230. In detail, the online game packet may have a different overall structure and different information depending on a type of online game packet.

When the online game packet is the first type, the online game packet generation information may include the protocol ID information, the packet size information, and the character status information of the game client. Further, the online game packet generation method may acquire a predetermined protocol index table. Here, the protocol index table may include at least one protocol index number and information about a structure of a protocol field corresponding to the at least one protocol index number. The game server and the game client may acquire the protocol index table in advance. Thus, when the online game packet is received, the game server and the game client may interpret the online game packet using the protocol index table. In an exemplary embodiment, the protocol index table may be generated or changed by a predetermined rule for security. In this instance, the game server and the game client may acquire the same protocol index table.

Moreover, the online game packet generation method may generate data values of the protocol index field and the at least one protocol field using the character status information based on the protocol index table. In detail, the online game packet generation method may generate data values of the protocol ID field and the packet size field using the generation information. Subsequently, the online game packet generation method may extract a protocol index number and information about a protocol field structure corresponding to the character status information of the game client based on the predetermined protocol index table. Accordingly, the online game packet generation method may determine a data value corresponding to the protocol index number as the data value of the protocol index field. Here, the information about the protocol field structure may correspond to the protocol index number. For example, the at least one protocol field may be in a different order according to each protocol index number, meaning that the protocol field structure may be variable on the protocol index number. The online game packet generation method may determine the data value of the at least one protocol field using the information about the protocol field structure and the character status information of the game client. Accordingly, the online game packet generation method may generate online game packets with various structures even when the packets have the same protocol ID.

The online game packet generation method may encode the data value of the protocol index field to prevent the illegal user from analyzing the online game packet. In this instance, the online game packet generation method may encode the data value of the protocol index field using a predetermined algorithm. Further, in the exemplary embodiment, the online game packet generation method may encode not only the data value of the protocol index field but also all data values of the online game packet.

For example, the illegal user may capture and analyze a game packet transmitted and received between the game server and the game client, change data of the game packet into random data, and transmit the random data to the server. Further to this example, the illegal user may analyze the game packet to identify a location of a protocol field corresponding to x, y and z coordinates and manipulate relevant data values to generate and transmit a game packet that transfer a character of the illegal user to an abnormal location. In the exemplary embodiment, however, since the online game packet may have various packet structures even with the same protocol ID, the illegal user may not analyze the packet structure. Thus, using the online game packet according to the exemplary embodiment, the online game packet generation method may prevent the illegal user from cheating and detect the illegal user who changes the online game packet.

When the online game packet is the second type, the online game packet generation information may further include character motion information about the game client. Further, the online game packet generation method may acquire a predetermined animation index table. Here, the animation index table may include at least one animation index number and information about a character motion type of the game client corresponding to the at least one animation index number. The game server and the game client may acquire the animation index table in advance. Thus, the game server and the game client may receive the online game packet and interpret the online game packet using the animation index table. In the exemplary embodiment, the animation index table may be generated and changed by a predetermined algorithm for security. In this case, the same server and the game client may acquire the same animation index table.

Subsequently, the online game packet generation method may generate a data value of the animation index field using the character motion information based on the animation index table. In detail, the online game packet generation method may generate data values of the protocol ID field and the packet size field using the generation information. Further, the online game packet generation method may determine a data value of the at least one protocol field based on the character status information included in the online game packet generation information using a predetermined rule. The online game packet generation method may extract the character motion type of the game client from the predetermined protocol index table using the character motion information about the game client, thereby extracting an animation index number corresponding to the character motion type of the game client. The online game packet generation method may determine a data value corresponding to the animation index number as the data value of the animation index field.

The online game packet generation method may encode the data value of the animation index field to prevent the illegal user from analyzing the online game packet. In this case, the online game packet generation method may encode the data value of the animation index field using a predetermined algorithm.

For instance, the illegal user may capture an online game packet transmitted and received between the game server and the game client and analyze and manipulate data values of the packet. In the online game packet of the exemplary embodiment, however, the illegal user may not acquire the animation index table and thus, the packet may be manipulated without analysis of the animation index field. In this case, a game character of the illegal user may perform awkward motions and thus, normal users may detect the illegal user.

When the online game packet is the third type, the online game packet generation information may further include character motion information about the game client. Further, the online game packet generation method may acquire a predetermined protocol index table and a predetermined animation index table. Here, the protocol index table may include at least one protocol index number and information about a structure of a protocol field corresponding to the at least one protocol index number. The animation index table may include at least one animation index number and information about a character motion type of the game client corresponding to the at least one animation index number. Further, similar to the first type, the online game packet generation method may generate data values of the protocol index field and the at least one protocol field using the character status information based on the protocol index table. Also, similar to the second type, the online game packet generation method may generate a data value of the animation index field using the character motion information based on the animation index table.

Then, the online game packet generation method may encode the data value of the protocol index field and the data value of the animation index field. In this case, the online game packet generation method may encode the data value of the protocol index field and the data value of the animation index field using a predetermined algorithm.

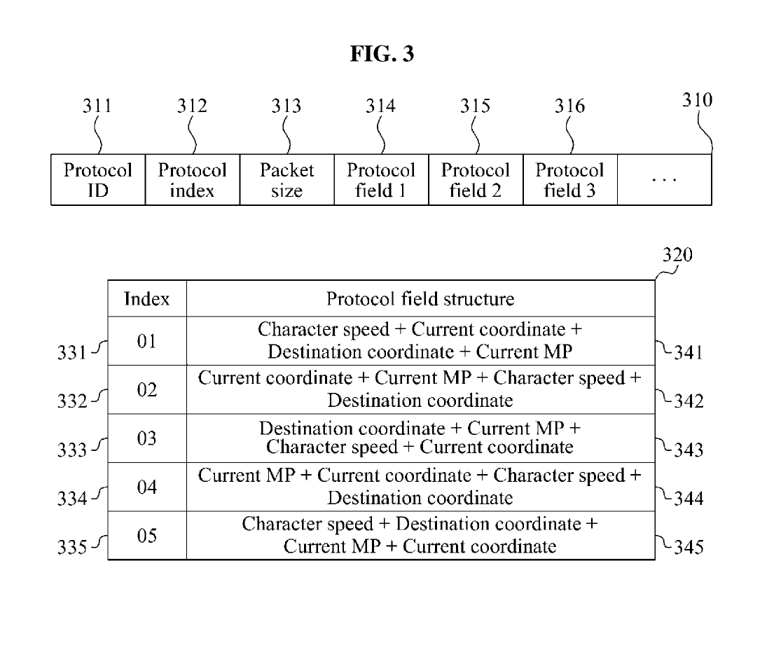

FIG. 3 illustrates the first type of online game packet according to an exemplary embodiment of the present invention.

Referring to FIG. 3, when the online game packet is the first type, the online game packet 310 may include a protocol ID field 311, a protocol index field 312, a packet size field 313, and at least one protocol field 314 to 316. Here, the protocol index field 312 may be a subfield of the protocol ID field 311.

The game server and the game client may acquire a predetermined protocol index table 320. Here, the protocol index table 320 may include at least one protocol index number 331 to 335 and information 341 to 345 about a structure of a protocol field corresponding to the at least one protocol index number 331 to 335.

For example, the online game packet generation method may generate an online game packet having a packet structure including a 4-byte protocol ID field, a 1-byte protocol index field, a 2-byte packet size field and data values of the fields of 13 00 00 00 01 31 00 32 00 00 00 64 01 00 00 0A 10 00 00 EF 02 00 00 75 01 00 00 0F 10 00 00 FF 02 00 00 C0 00 00 00, [. . . ]. In this case, the game server or the game client receiving the online game packet may interpret the online game packet using the predetermined protocol index table 320. Thus, since protocol ID information is 13 00 00 00 and a protocol index is 01, a character speed is interpreted as 32 00 00 00, current coordinates x, y and z as 64 01 00 00, 0A 10 00 00 and EF 02 00 00, destination coordinates x, y z as 75 01 00 00, 0F 10 00 00 and FF 02 00 00, and a current MP value as C0 00 00 00.

In the exemplary embodiment, in a different index number, the online game packet may be interpreted in a different sense. For example, in an index number of 03, destination coordinates x, y and z may be interpreted as 32 00 00 00, 64 01 00 00 and 0A 10 00 00, a current MP value as EF 02 00 00, a character speed as 75 01 00 00, and current coordinates x, y and z as 0F 10 00 00, FF 02 00 00 and C0 00 00 00. Thus, since the illegal user is unable to acquire the predetermined protocol index table 320, the illegal user may change the online game packet into in incorrect format, and thus, the online game packet generation method may effectively detect the illegal user.

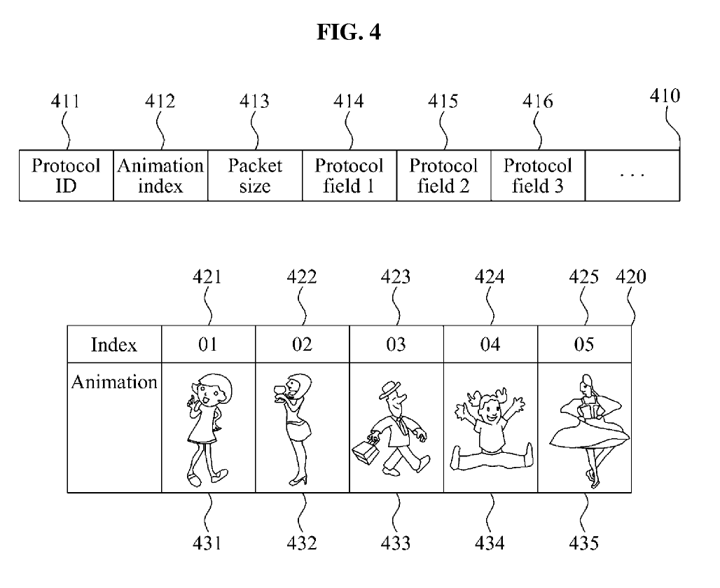

FIG. 4 illustrates the second type of online game packet according to an exemplary embodiment of the present invention.

Referring to FIG. 4, when the online game packet is the second type, the online game packet 410 may include a protocol ID field 411, an animation index field 412, a packet size field 413, and at least one of protocol fields 414 to 416. Here, a data value of the at least one of protocol fields 414 to 416 may be determined using a predetermined rule based on the character status information of the game client included in the online game packet generation information.

The game server and the game client may acquire a predetermined animation index table 420. Here, the animation index table may include at least one animation of index numbers 421 to 425 and information 431 to 435 about a character motion type of the game client corresponding to the at least one of animation index numbers 421 to 425.

For example, the online game packet generation method may generate an online game packet having a packet structure including a 4-byte protocol ID field, a 1-byte animation index field, a 2-byte packet size field and data values of the fields of 13 00 00 00 04 31 00, [. . . ]. In this case, the online game packet generation method may interpret the online game packet using the predetermined animation index table 420. Thus, since protocol ID information 13 00 00 00 and an animation index is 04, the online game packet generation method may interpret the online game packet as that a character of the game client performs a jump motion.

Here, when the illegal user captures and analyzes the online game packet, the illegal user cannot acquire the animation index table and thus, may transmit an online game packet allowing awkward motions to the game server. Thus, normal users identify a game character performing an awkward motion as an illegal user, thereby effectively detecting the illegal user.

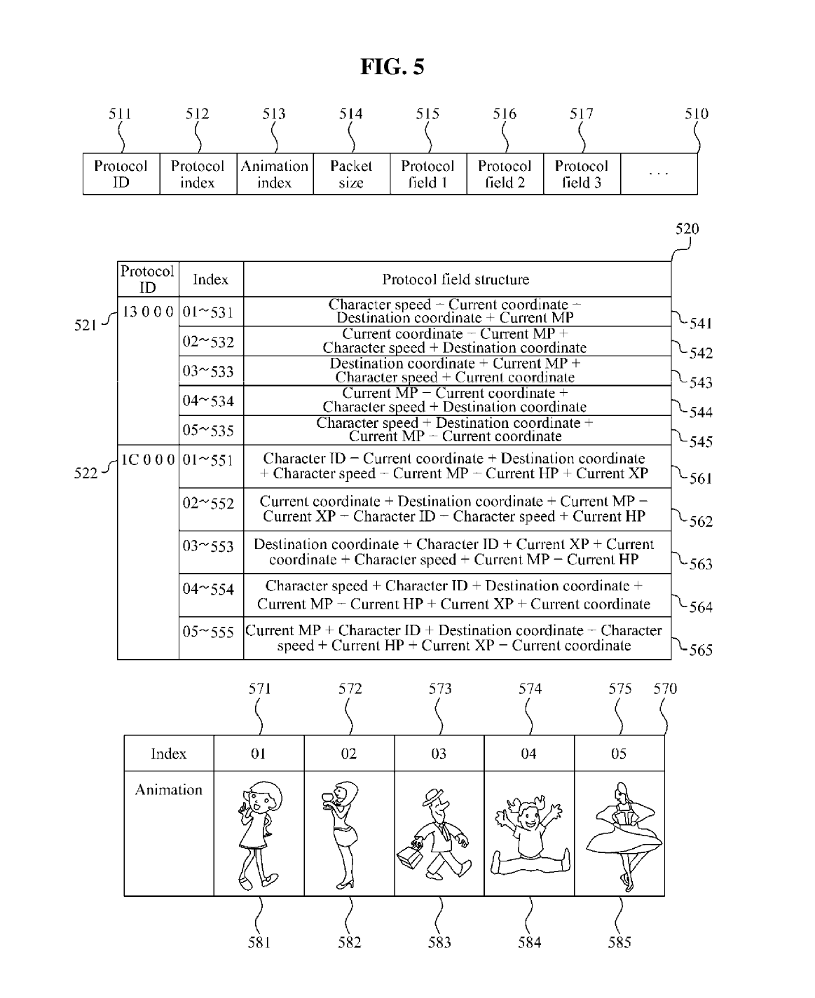

FIG. 5 illustrates the third type of online game packet according to an exemplary embodiment of the present invention.

Referring to FIG. 5, an online game packet 510 may include a protocol ID field 511, a protocol index field 512, an animation index field 513, a packet size field 514, and at least one protocol field 515 to 517. Here, the protocol index field 512 may be a subfield of the protocol ID field 511.

The game server and the game client may acquire a predetermined protocol index table 520. Here, the protocol index table 520 may include a protocol ID 521 and 522, at least one of protocol index numbers 531 to 535 and 551 to 555 corresponding to each protocol ID and information 541 to and 561 to 565 about a structure of a protocol field corresponding to the at least one of protocol index numbers 531 to 535 and 551 to 555.

In addition, the game server and the game client may acquire a predetermined animation index table 570. Here, the animation index table 570 may include at least one of animation index numbers 571 to 575 and information 581 to 585 about a character motion type of the game client corresponding to the at least one animation index number 571 to 575.

For example, the online game packet generation method may generate an online game packet having a packet structure including a 4-byte protocol ID field, a 1-byte protocol index field, a 1-byte animation index field, a 2-byte packet size field and data values of the fields of 1C 00 00 00 03 05 31 00 32 00 00 00 64 01 00 00 0A 10 00 00 EF 02 00 00 75 01 00 00 0F 10 00 00 FF 02 00 00 C0 00 00 00 25 03 02 06 35 31 84 00 92 84 67 03, [. . . ]. In this case, the online game packet generation method may interpret the online game packet using the predetermined protocol index table 520 and the predetermined animation index table 570. Thus, since a protocol ID is 1C 00 00 00 and a protocol index is 03, the online game packet generation method may interpret destination coordinates x, y and z as 32 00 00 00, 64 01 00 00 and 0A 10 00 00, a character ID as EF 02 00 00, a current XP value as 75 01 00 00, current coordinates x, y and z as 0F 10 00 00, FF 02 00 00 and C0 00 00 00, a character speed as 25 03 02 06, a current MP value as 35 31 84 00, and a current HP value as 92 84 67 03. Further, since an animation index is 05, a game character having the character ID of EF 02 00 00 may move to the destination coordinates, with one foot making a circle. In a different protocol ID or index number, the online game packet may be interpreted in a different sense. Thus, since an illegal user cannot acquire the predetermined protocol index table 520 and the animation index table 570, the online game packet generation method may effectively detect the illegal user and normal users may also easily identify the illegal user.

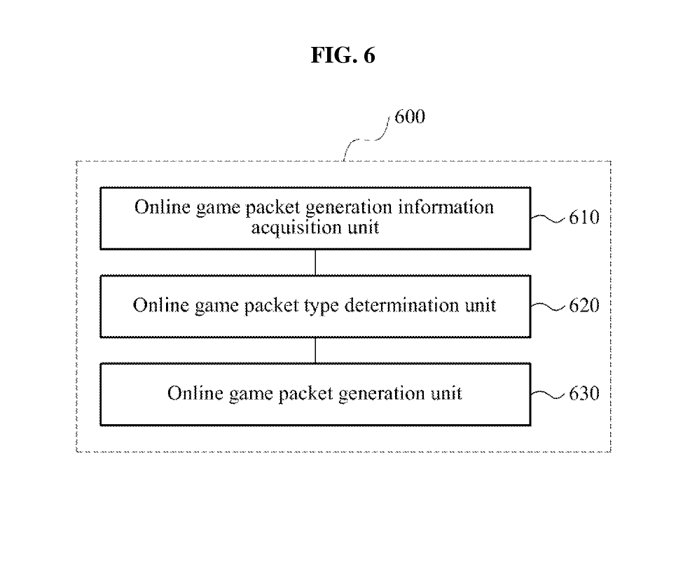

FIG. 6 illustrates an apparatus for generating an online game packet for detection of an illegal user according to an exemplary embodiment of the present invention.

Referring to FIG. 6, an online game packet generation information acquisition unit 610 may acquire online game packet generation information including protocol ID information and packet size information.

An online game packet type determination unit 620 may determine a type of online game packet basically having a packet structure including a protocol ID field corresponding to the protocol ID information, a packet size field corresponding to the packet size information and at least one protocol field, and further including at least one of a protocol index field and an animation index field.

An online game packet generation unit 630 may generate the online game packet using the online game packet generation information based on the type of online game packet.

Identical descriptions provided with reference to FIGS. 1 to 5 may be applied to the apparatus for generating the online game packet for detection of the illegal user 600 illustrated in FIG. 6, and thus repeated descriptions of the apparatus are omitted herein for conciseness.

While the present invention has been shown and described with reference to a few exemplary embodiments and the accompanying drawings, it will be apparent to those skilled in the art that various modifications and variations can be made in the present invention without departing from the spirit or scope of the invention. For example, adequate effects of the present invention may be achieved even if the foregoing processes and methods may be carried out in different order than described above, and/or the aforementioned elements, such as systems, structures, devices, or circuits, may be combined or coupled in different forms and modes than as described above or be substituted or switched with other components or equivalents.

Thus, it is intended that the present invention cover the modifications and variations of this invention provided they come within the scope of the appended claims and their equivalents.

What is claimed is:

1. A method of generating an online game packet for detection of an illegal user, the method comprising:
acquiring online game packet generation information comprising protocol identification (ID) information, packet size information, and character status information of a game client;
determining a type of online game packet having a basic packet structure comprising a protocol ID field corresponding to the protocol ID information, a packet size field corresponding to the packet size information and at least one protocol field corresponding to the character status information of the game client, and further comprising at least one of a protocol index field and an animation index field; and
generating the online game packet using the online game packet generation information based on the type of online game packet.

2. The method of claim 1, wherein the type of online game packet is any one of a first type having the basic packet structure and further comprising the protocol index field, a second type having the basic packet structure and further comprising the animation index field, and a third type having the basic packet structure and further comprising the protocol index field and the animation index field.

3. The method of claim 2, wherein when the online game packet is the first type, the generating of the online game packet comprises acquiring a predetermined protocol index table, generating data values of the protocol index field and the at least one protocol field using the character status information based on the protocol index table, and encoding the data value of the protocol index field.

4. The method of claim 3, wherein the protocol index table comprises at least one protocol index number and information about a structure of a protocol field corresponding to the at least one protocol index number.

5. The method of claim 2, wherein when the online game packet is the second type, the online game packet generation information further comprises character motion information about the game client, and the generating of the online game packet comprises acquiring a predetermined animation index table, generating a data value of the animation index field using the character motion information based on the animation index table, and encoding the data value of the animation index field.

6. The method of claim 5, wherein the animation index table comprises at least one animation index number and information about a character motion type of the game client corresponding to the at least one animation index number.

7. The method of claim 2, wherein when the online game packet is the third type, the online game packet generation information further comprises character motion information about the game client, and the generating of the online game packet comprises acquiring a predetermined protocol index table, acquiring a predetermined animation index table, generating data values of the protocol index field and the at least one protocol field using the character status information based on the protocol index table, generating a data value of the animation index field using the character motion information based on the animation index table, and encoding the data value of the protocol index field and the data value of the animation index field.

8. The method of claim 7, wherein the protocol index table comprises at least one protocol index number and information about a structure of a protocol field corresponding to the at least one protocol index number, and the animation index table comprises at least one animation index number and information about a character motion type of the game client corresponding to the at least one animation index number.

9. The method of claim 1, wherein the protocol index field is a subfield of the protocol ID field.

10. An apparatus for generating an online game packet for detection of an illegal user, the apparatus comprising:
an online game packet generation information acquisition unit to acquire online game packet generation information comprising protocol identification (ID) information, packet size information, and character status information of a game client;
an online game packet type determination unit to determine a type of online game packet having a basic packet structure comprising a protocol ID field corresponding to the protocol ID information, a packet size field corresponding to the packet size information and at least one protocol field corresponding to the character status information of the game client, and further comprising at least one of a protocol index field and an animation index field; and
an online game packet generation unit to generate the online game packet using the online game packet generation information based on the type of online game packet.

11. The apparatus of claim 10, wherein the type of online game packet is any one of a first type having the basic packet structure and further comprising the protocol index field, a second type having the basic packet structure and further comprising the animation index field, and a third type having the basic packet structure and further comprising the protocol index field and the animation index field.

12. The apparatus of claim 11, wherein when the online game packet is the first type, the online game packet generation unit comprises a protocol index table acquisition unit to acquire a predetermined protocol index table, a data value generation unit to generate data values of the protocol index field and the at least one protocol field using the character status information based on the protocol index table, and an encoding unit to encode the data value of the protocol index field.

13. The apparatus of claim 12, wherein the protocol index table comprises at least one protocol index number and information about a structure of a protocol field corresponding to the at least one protocol index number.

14. The apparatus of claim 11, wherein when the online game packet is the second type, the online game packet generation information further comprises character motion information about the game client, and the online game packet generation unit comprises an animation index table acquisition unit to acquire a predetermined animation index table, a data value generation unit to generate a data value of the animation index field using the character motion information based on the animation index table, and an encoding unit to encode the data value of the animation index field.

15. The apparatus of claim 14, wherein the animation index table comprises at least one animation index number and information about a character motion type of the game client corresponding to the at least one animation index number.

16. The apparatus of claim 11, wherein when the online game packet is the third type, the online game packet generation information further comprises character motion information about the game client, and the online game packet generation unit comprises a protocol index table acquisition unit to acquire a predetermined protocol index table, an animation index table acquisition unit to acquire a predetermined animation index table, a first data value generation unit to generate data values of the protocol index field and the at least one protocol field using the character status information based on the protocol index table, a second data value generation unit to generate a data value of the animation index field using the character motion information based on the animation index table, and an encoding unit to encode the data value of the protocol index field and the data value of the animation index field.

17. The apparatus of claim 16, wherein the protocol index table comprises at least one protocol index number and information about a structure of a protocol field corresponding to the at least one protocol index number, and the animation index table comprises at least one animation index number and information about a character motion type of the game client corresponding to the at least one animation index number.

18. The apparatus of claim 10, wherein the protocol index field is a subfield of the protocol ID field.
